(19) United States
(12) Patent Application Publication
(10) Pub. No.: US 2003/0142036 A1
(43) Pub. Date: Jul. 31, 2003

(54) Multiband or broadband frequency selective surface

(76) Inventors: Michael John Wilhelm, Stillwater, OK (US); Douglas H. Werner, State College, PA (US); Pingjuan L. Werner, State College, PA (US); Jeffrey S. Daniels, Stillwater, OK (US); Lance D. Swann, Stillwater, OK (US); William L. Warren, Stillwater, OK (US)

Correspondence Address: NEEDLE & ROSENBERG P C, 127 PEACHTREE STREET N E, ATLANTA, GA, 30303-1811, US

(21) Appl. No.: 10/305,793

(22) Filed: Nov. 27, 2002

Related U.S. Application Data
(63) Continuation-in-part of application No. 10/072,739, filed on Feb. 8, 2002.
(60) Provisional application No. 60/267,146, filed on Feb. 8, 2001.
(60) Provisional application No. 60/349,185, filed on Jan. 15, 2002.
(60) Provisional application No. 60/302,375, filed on Jul. 3, 2001.
(60) Provisional application No. 60/333,702, filed on Nov. 27, 2001.

(51) Int. Cl. H01Q 15/02; H01Q 19/00

(52) U.S. Cl. 343/909; 343/756; 343/700 MS

(57) ABSTRACT

A frequency selective surface includes a pattern of electromagnetic material formed on a substrate suspendable over a ground plane for reflecting or transmitting electromagnetic waves at one or more particular frequencies. The frequency selective surface may include one or more meandering line inductors and/or one or more interdigitated capacitors formed within the pattern of electromagnetic materials for adjusting the frequencies at which the electromagnetic waves are reflected or transmitted. The frequency selective surface may also or instead include one or more inductors and/or one or more capacitors arranged in series within the pattern of electromagnetic materials to adjust the frequencies at which the electromagnetic waves are reflected or transmitted. In addition, the pattern of electromagnetic materials may be formed within the substrate in such a manner that the frequencies at which the electromagnetic waves are reflected or transmitted are tunable. The elements of the FSS may include lumped passive or active devices.

### CROSS-REFERENCE TO RELATED APPLICATIONS

This application is a Continuation-in-part of U.S. patent application Ser. No. 10/072,739 filed on Feb. 8, 2002, which itself claims priority from commonly assigned U.S. Provisional Patent Application No. 60/267,146, filed on Feb. 8, 2001, and U.S. Provisional Patent Application No. 60/349,185, filed on Jan. 15, 2002. These applications are hereby incorporated by reference. In addition, this application is a Continuation-in-part of U.S. patent application Ser. No. 10/188,909 filed on Jul. 3, 2002, which itself claims priority from U.S. Provisional Application No. 60/302,375 filed Jul. 3, 2001. These applications are also hereby incorporated by reference. Also, this application claims the benefit of U.S. Provisional Application No. 60/333,702 filed on Nov. 27, 2002 and hereby incorporated by reference.

### BACKGROUND

The present invention is directed to frequency selective surfaces and photonic band gaps. More particularly, the present invention is directed to a frequency selective surface with multiband or broadband capabilities.

There exists a broad category of microwave and radio frequency (RF) devices called frequency selective surfaces (FSSs). FSSs are, in general, surfaces with properties that are functions of frequency. FSSs may be used to alter or otherwise affect the properties of electromagnetic waves that are reflected and/or transmitted from/through them. FSSs have also been referred to as photonic band-gap (PBB) materials, owing to their similarity in function to the behavior of electrons in semi conducting crystals. Strictly speaking, the operation of PBG materials strongly depends on the periodic nature of embedded objects (discontinuities) within their structure. Due to the many similarities in construction between FSSs and PBG, there is often an overlap in the terminology.

One particular type of FSS or PBG is a high-impedance surface. The high-impedance surface is a particular type of FSS or PBG that is used to suppress surface waves. When the high-impedance surface effect is combined with the ability to reflect an incident electromagnetic (EM) wave, this combination of properties has the effect of an artificial magnetic conductor (AMC) or perfect magnetic conductor (PMC). The AMC (or PMC) is thus a particular type of FSS or PBG.

FSSs, PBGs, and in particular, AMCs and PMCs achieve their effects through the resonant properties of the features formed into their surfaces. They are thus in general, narrow-band devices.

In general, FSSs use the properties of resonant cells to control the properties of a reflected, absorbed, or transmitted EM wave; the PBG uses the properties of a periodic array of discontinuities to control the properties of a reflected, absorbed, or transmitted EM wave. By controlling the properties of waves, FSSs and PBGs find many applications in antenna engineering.

One of the main drawbacks with FSSs, PBGs, and in particular high impedance surfaces, is their characteristically narrowband response due to their dependence on the resonance of an embedded circuit. All known high-impedance surfaces utilize the parallel inductor-capacitor (LC) model to describe their behavior; high-impedance effects only occur at frequencies where the surface is resonant.

FIG. 1A illustrates a conventional high-impedance structure consisting of islands of metal formed on a substrate 100 over a ground plane 105. The islands are connected by lines, forming a metal pattern 110. This structure is equivalent to an array of parallel inductor-capacitor (LC) circuits, such as that shown in FIG. 1B.

The resonant frequency fₒ of the parallel LC circuit, or the frequency at which surface waves are suppressed, is given by fₒ=1/(2π√(LC)).

The structure represented in FIGS. 1A and 1B has relatively low values of inductance and capacitance, with a stopband located around 12 GHz. In this stop band, surface waves are suppressed. This FSS is not suitable for many applications, such as cell phones, etc., that operate at frequencies lower than 12 GHz. Also, this structure is not capable of multiband or wideband performance. Thus, to improve state of the art, it is desired to create lower-frequency FSSs, in particular high-impedance surfaces, by increasing the surface inductance and capacitance and bringing the resonant frequencies below 3 GHz where many more communications devices can make use of them.

Thus, there is a need for lower-frequency frequency selective surfaces that are capable of wideband or multiband performance.

### SUMMARY

It is therefore an object of the present invention to provide a frequency selective surface capable of wideband or multiband performance. It is a further object of the present invention to produce a frequency selective surface capable of wideband or multiband performance.

According to exemplary embodiments, a frequency selective surface includes a pattern of electromagnetic material formed on a substrate suspendable over a ground plane for reflecting or transmitting electromagnetic waves at one or more particular frequencies. The electromagnetic waves may propagate in free space. Alternatively, the electromagnetic waves may be surface currents or transmission-line currents. Also, the pattern of electromagnetic materials and the meandering line inductors and/or interdigitated capacitors affect the phase of at least one electromagnetic wave that is reflected or transmitted. The inductors and/or capacitors may be arranged in one or more cells, and the cells may be arranged within the frequency selective surface in a periodic design or space-saving design. The electromagnetic waves may be caused to be reflected or transmitted at multiple frequencies by distributed or parasitic effects in the inductors and/or the capacitors, and the properties of the waves (e.g., amplitude and/or phase) may be controlled by the surface in the process. Also, inductance values and capacitance values may be adjusted by varying the geometries of the inductors and capacitors, respectively. A frequency at which electromagnetic waves are reflected or transmitted is adjusted by applying magnetic and/or dielectric material on either side or both sides of the pattern of electromagnetic material. The magnetic and/or dielectric materials may be intermixed to cause multiband or wide-band reflection, absorption, or transmission of the electromagnetic waves. The inductors and/or capacitors may be arranged in a self-similar pattern or a pseudo self-similar pattern or in a stochastic or substantially random pattern. The frequency selective surface prohibits surface waves from propagating on a substrate and thus can be used to prevent the escape of electromagnetic waves from the substrate at some frequencies, allowing electromagnetic waves at particular other desired frequencies to escape. Also, the frequency selective surface may be formed in an area of a printed circuit board at which cables are attached, blocking unwanted electromagnetic waves from escaping onto the cables and allowing electromagnetic waves at desired frequencies to escape.

According to one embodiment, the frequency selective surface includes one or more meandering line inductors and/or one or more interdigitated capacitors formed within the pattern of electromagnetic materials for adjusting the frequencies at which the electromagnetic waves are reflected or transmitted.

According to another embodiment, the frequency selective surface includes one or more inductors and/or one or more capacitors arranged in series within the pattern of electromagnetic materials to adjust the frequencies at which the electromagnetic waves are reflected or transmitted.

According to yet another embodiment, the frequency selective surface comprises a pattern of electromagnetic materials formed within a substrate suspendable over a ground plane to reflect or transmit electromagnetic waves at one or more frequencies, wherein the pattern is arranged in such a manner that the frequencies at which the electromagnetic waves are reflected or transmitted are tunable. According to this embodiment, the electromagnetic materials may be formed on a substrate that is tunable by applying an electric or magnetic field or an AC or DC bias voltage or current. Also, the substrate may include a field tunable dielectric or magnetic material which is tuned by applying a bias field. One or more tunable meandering-line inductors or interdigitated capacitors may be arranged within the pattern of electromagnetic material. Inductance may be changed by opening or short-circuiting an inductance changing path of the line inductors, and capacitance is changed by connecting or disconnecting fingers of the interdigitated capacitors. Diodes and/or transistors or an optically active device may be used for opening or short circuiting the inductance changing path and/or for connecting or disconnecting the fingers of the interdigitated capacitors.

Alternatively, electrical circuits composed of active and/or passive devices may be embedded into or attached onto the surface. The active and/or passive devices may be used to actively control the properties of the surface or to provide enhanced static behaviors.

The frequency selective surface, photonic band gap surfaces, or high-impedance surfaces may be connected to an antenna to enable beam steering and/or focusing.

The objects, advantages and features of the present invention will become more apparent when reference is made to the following description taken in conjunction with the accompanying drawings.

### BRIEF DESCRIPTION OF THE DRAWINGS

FIGS. 1A and 1B illustrate a conventional high-impedance frequency selective surface and an equivalent circuit, respectively;

FIG. 2 illustrates a plot of surface wave transmission properties for a low frequency frequency selective surface according to an exemplary embodiment;

FIGS. 3A-3C and 4A-4B illustrate cells and arrays for an exemplary low frequency FSS according to an exemplary embodiment;

FIGS. 5 and 6A-6B illustrate exemplary close-fitting space-efficient designs for a low frequency FSS according to an exemplary embodiment;

FIGS. 7, 8A and 8B illustrate a cell cluster and arrangements of clusters in a multiband frequency selective surface according to an exemplary embodiment;

FIG. 9 illustrates exemplary application of materials to an FSS array for multiband performance according to an exemplary embodiment;

FIGS. 10A and 10B illustrate stacked FSS screens for providing multiband performance according to an exemplary embodiment;

FIG. 11 illustrates an exemplary FSS design with different amounts of dielectrics and ferrites according to an exemplary embodiment;

FIGS. 12A and 12B illustrate plots of parallel LC resonant bandwidth as related to a ratio L/C;

FIG. 13 illustrate an exemplary configuration for a highly inductive frequency selective surface according to an exemplary embodiment;

FIGS. 14A-14C illustrate an exemplary Sievenpiper high impedance frequency selective surface;

FIGS. 15A and 15B illustrate an exemplary frequency selective surface having self-similar molecules and a self-similar conducting plane according to an exemplary embodiment;

FIGS. 16A and 16B illustrate plots of exemplary reflection coefficient responses of series and parallel LC circuits, respectively;

FIGS. 17A and 17B illustrate capacitive and inductive surfaces;

FIGS. 18A and 18B illustrate one example of a series LC FSS and a circuit equivalent, respectively, according to an exemplary embodiment;

FIGS. 19A and 19B illustrate plots of how L/C affects the bandwidth of a series LC circuit;

FIGS. 20A-20C illustrate tunable interdigitated capacitors using diode-switched fingers according to an exemplary embodiment;

FIGS. 21A-21D illustrate fabrication of a diode-switched tunable interdigitated capacitor according to an exemplary embodiment;

FIGS. 22A and 22B illustrate plots of the effects of negative loads on resonant frequencies according to exemplary embodiments;

FIGS. 23A-23C illustrate exemplary active loads included in a FSS for tunable and wideband performance according to an exemplary embodiment;

FIG. 24 illustrates an exemplary antenna system including an FSS according to an exemplary embodiment;

FIGS. 25A and 25B illustrate a typical printed circuit board (PCB)/cable arrangement and an exemplary PCB/cable arrangement including an FSS, respectively;

FIGS. 26A and 26B illustrate another embodiment of a series LC high-impedance surface, with FIG. 26A showing the progression from a simple series LC transmission line model through realization, and FIG. 26B illustrating the realization in detail; and

FIGS. 27A and 27B show an exemplary tunable meandering line inductor.

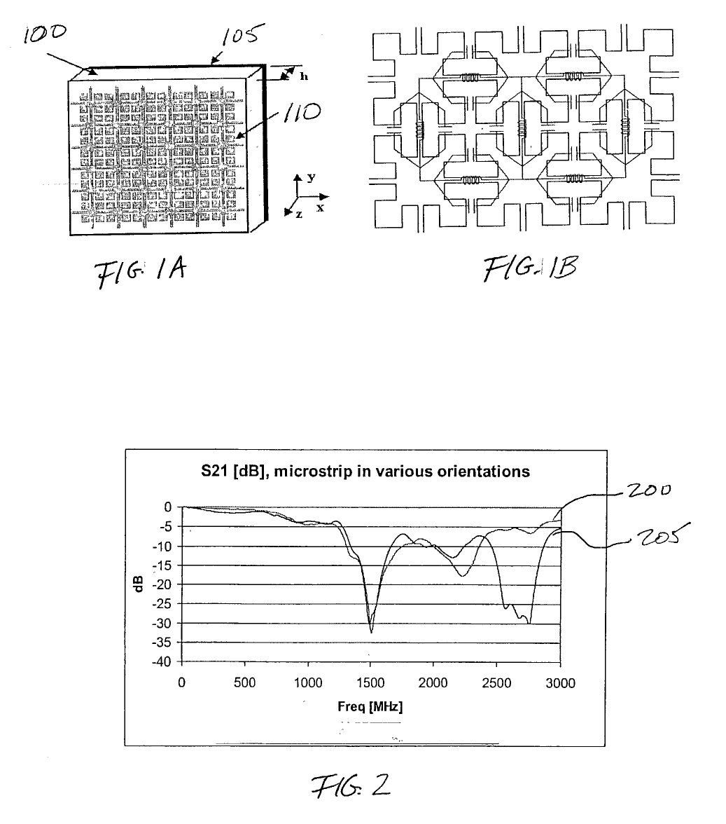

### DETAILED DESCRIPTION

According to exemplary embodiments, various approaches may be used for developing enhanced designs for frequency selective surfaces, photonic bandgap materials, and high impedance surfaces. For simplicity of illustration, high impedance surfaces, FSSs and PBGs are collectively referred to in portions of the following as FSSs. It will be appreciated, however, that the description applies to FSSs, PBGs, and high-impedance surfaces.

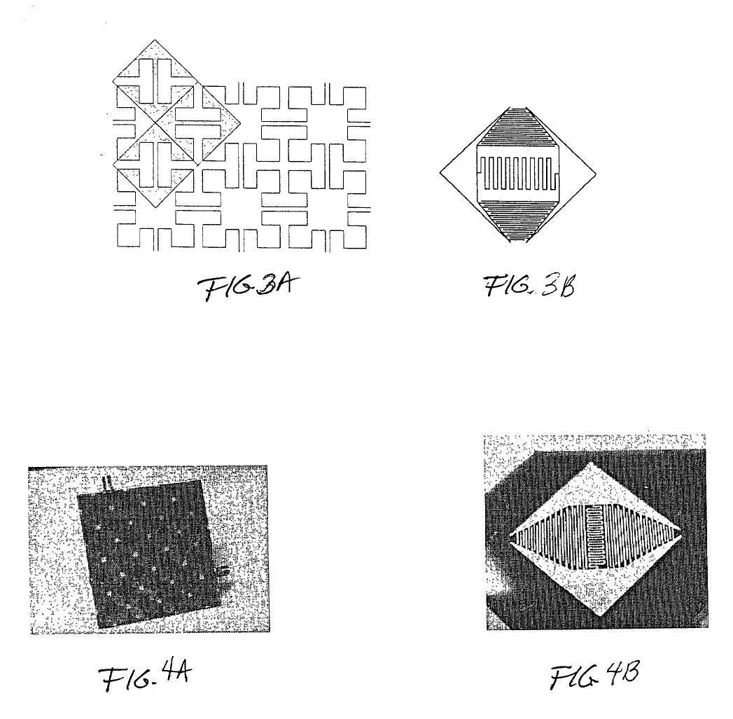

To be suitable for many commercial wireless applications, an FSS should have a low frequency stopgap, e.g., a stopgap less than 3 GHz. FIG. 2 illustrates an exemplary plot of surface-wave transmission properties for a structure including a microstrip transmission line applied over the FSS's inductors and a structure including a microstrip transmission line applied over the FSS's gaps. Line 200 represents the properties of the structure including a microstrip applied over inductors, and line 205 represents the properties the structure including the microstrip applied over gaps. As shown in FIG. 2, the fundamental (non-parasitic) stopgap for both structures is around 1.5 GHz. This lower frequency surface is suitable for applications such as cellular phones, GPS, and Bluetooth which operate at around 2.4 GHz.

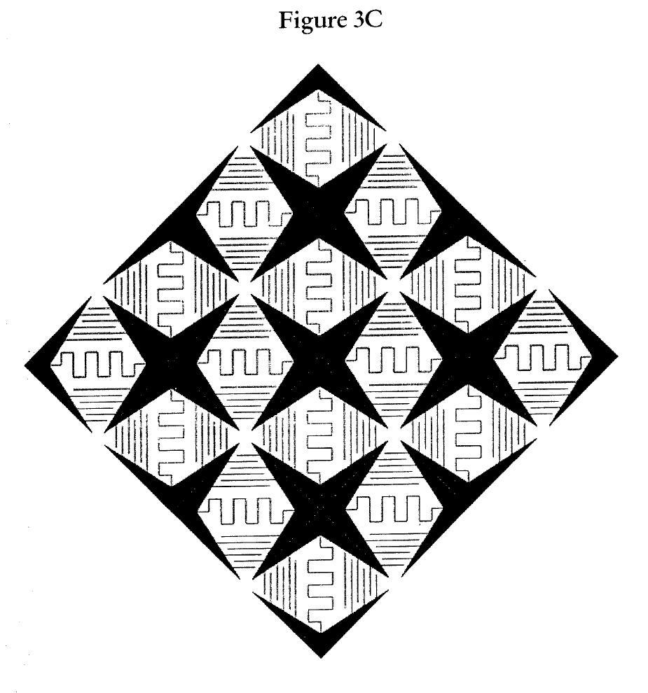

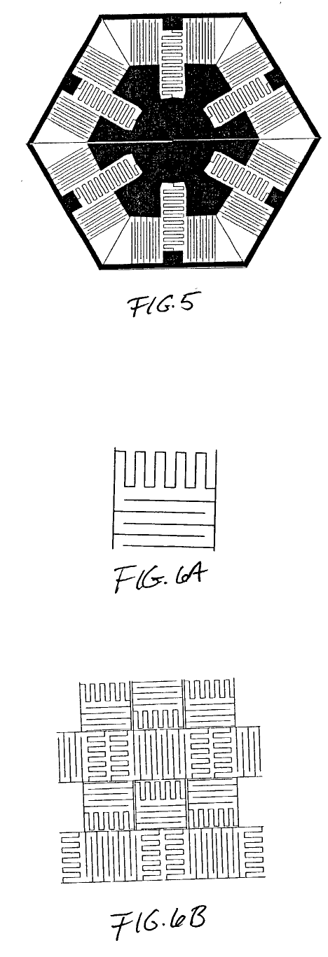

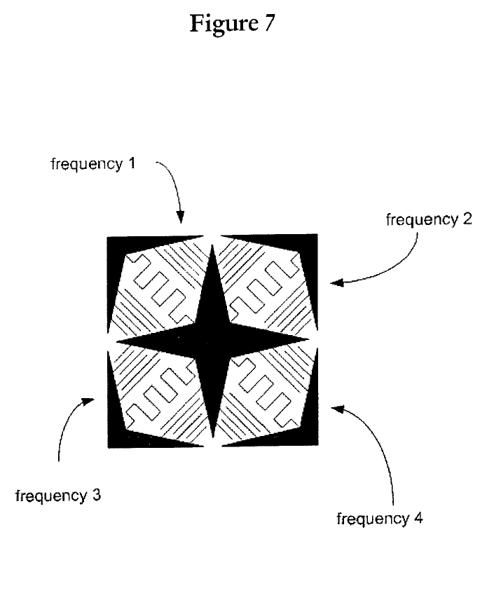

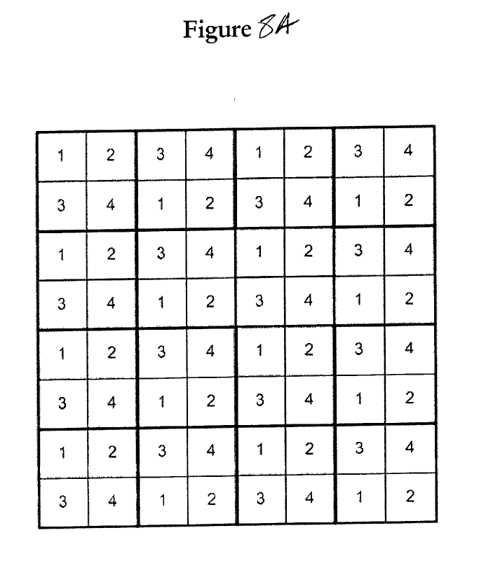

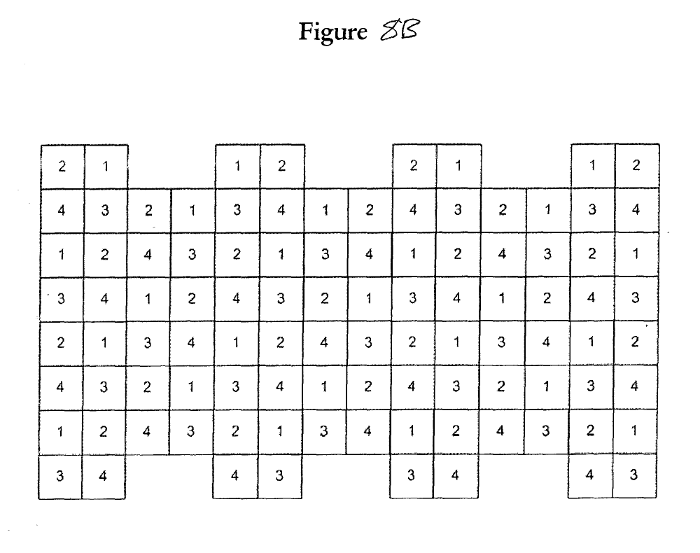

According to exemplary embodiments, the stopgap of the FSS may be made lower in frequency without varying the surface area by increasing the values of the capacitance (C) and the inductance (L) within the FSS and using interdigitated capacitors and meandering line inductors, respectively. Exemplary configurations are shown in FIGS. 3A-4B.

FIG. 3A shows an equivalent circuit of a conventional FSS with capacitors and inductors overlayed on the FSS surface. FIGS. 3B and 4B illustrate an exemplary cell within an FSS according to exemplary embodiments where the capacitors have been enhanced by using the interdigitated capacitors and the inductances have been enhanced by using meandering line inductors. FIGS. 3C and 4A illustrate an exemplary array of cells.

While these designs are an improvement, it is apparent from FIGS. 3B-4B that there is unfilled space on the substrate surface. In some applications, such as high-impedance surface devices, the unfilled space degrades performance by creating local regions of low-impedance material and should be minimized when possible.

According to an exemplary embodiment, the cells may be arranged in a space-saving design, such as a closely packed hexagonal array. FIG. 5 illustrates an exemplary hexagonal array. FIGS. 6A and 6B illustrate an exemplary space-saving cell and array, respectively.

In addition, the space-saving design, such as the hexagonal array shown in FIG. 5, an FSS may also have various different geometric designs for the meandering inductor. Referring to FIG. 5, for example, the inductors may be designed to branch out further upon intersecting with the larger metal “pads” near the center to provide a larger inductor component to the FSS and minimizing the unfilled space.

Referring again to FIG. 2, the lower frequency FSS has multiple resonant frequencies. At these frequencies, surface waves are prevented from propagating. The additional two resonance frequencies arise from distributed or parasitic element effects in the L and C structures. Parasitic and distributed effects are the unwanted reactances observed in an object when its size has a notable effect on its value, e.g., the inductance of a capacitor or the capacitance of an inductor. By carefully controlling and adjusting these parasitic element effects, the additional resonant frequencies may be exploited and used to obtain multiple frequency operation or wide-band operation of the FSS.

According to an exemplary embodiment, one way of creating a multi-band or broadband FSS using multiple values of L and C is to form cells of inductors and capacitors such that each cell contains multiple resonant circuits and to tune each to a different frequency by using different values of L and/or C for each circuit within the cell to a different frequency. These different inductance and capacitance values may be achieved by varying the geometries of the inductors and capacitors. For example, the spacing between the interdigitated capacitor fingers and the lengths of these fingers may be varied. Also, the meandering line geometries of the inductors may be varied. By varying the values of L and C, the resonant frequencies of the circuits and cells are varied. Each cell will then display multiband operation.

According to exemplary embodiments, the cells do not need to be all of the same size. By creating an array of different sized cells, e.g., random or pseudo-random sized cells, an overall broadband operation can be achieved.

A unit defined as a “cluster” may contain a small array of cells, each cell having a different resonant frequency. The exact arrangement of the cells in this cluster is important to the overall behavior of the finished FSS. An exemplary 4-frequency cluster is shown in FIG. 7.

Clusters may be arranged in ways to distribute the properties of these multiband clusters across the surface. Exemplary arrangements of clusters are shown in FIGS. 8A and 8B, where the numbers 1-4 designate cells of different frequencies 1 through 4. Other arrangements are possible.

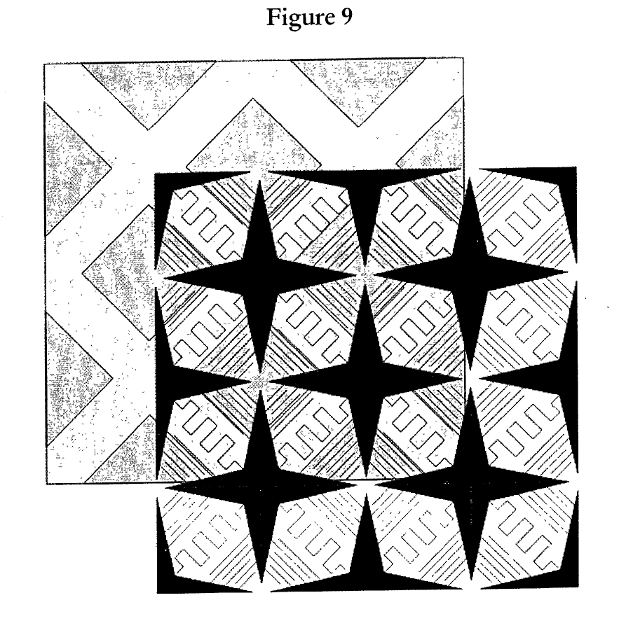

As an alternative, the resonant frequencies of individual FSS cells may be adjusted by applying various electric and magnetic materials on either side of or on both sides of the FSS conductive layer, whether it is a superstrate or a substrate. This is shown, for example, in FIG. 9. In FIG. 9 is shown the LC layer with meandering line inductors and interdigitated capacitors, offset to the lower right. The superstrate or substrate layer is shown offset to the upper left. Referring to the upper left cell, the darkly shaded area represents one particular dielectric, while the lightly shaded area represents one unique magnetic material. Thus, this cell has been uniquely tuned by its L and C geometries, as well as the characteristics of the media surrounding the cell. Adjacent cells need not use the same dielectric or magnetic materials. The magnetic and dielectric materials may be intermixed, thus allowing an even larger number of combination to create a multiband or broadband array.

According to another embodiment, multiband or broadband performance may be achieved by cascading several FSS screens together, i.e., stacking FSS layers on top of each other, as shown, e.g., in FIGS. 10A and 10B. In this design, each FSS screen has a different resonant frequency. The top screen has a resonant frequency of ω1, the next screen has a resonant frequency of ω2, the next screen has a resonant frequency of ω3, and the bottom screen has a resonant frequency of ω4. As can be seen from FIG. 10A, each screen reflects signals at its resonant frequency. These resonant frequencies may be spaced appropriately for either multiband or broadband behavior. The material properties (dielectric and/or magnetic) and thickness of the substrate and superstrate layer provide additional degrees of freedom for controlling the overall frequency response of the structure.

According to another embodiment, an array of cells of varying frequencies may be created by applying an array of same dielectric material of different dimensions to the capacitors of the FSS or an array of same permeability material of different dimensions to the inductors of the FSS. An exemplary FSS with this design is shown in FIG. 11. Size, shape and placement of the dielectric pads all affect the operating frequency of the FSS cell and may be used to tune the cell to the desired frequency. This technique may also be combined with the techniques illustrated in FIG. 9 to obtain the desired operating characteristics.

In addition to the stopgap induced by the resonant LC circuits embedded within or on the FSS, it is also possible to produce multi-resonant properties using the periodicity of the cells a cluster. This may be referred to as a photonic bandgap effect. In general, the size, shape, and periodicity of PBG elements all contribute to the material's operational frequency and bandwidth. In general, PBGs are material structures whose electric or magnetic susceptibility varies periodically in one, two, or three dimensions. When such structures are illuminated by an electromagnetic wave having a wavelength comparable to the spatial period of the crystal, the periodic variation causes distributed scattering. This is usually described by an electromagnetic dispersion relation (circular frequency w vs. wave vector k) that is modified substantially from the typical linear relation for propagation through linear, isotropic, and homogenous material. This modified form of scattering leads to the nomenclature of PBG because the distributed scattering and unmodified dispersion relations that occur for photons are analogous to the distributed scattering and band dispersion that occurs for electrons in an atomic crystal.

The stop band is the basis of many PBG applications. It is characterized by a strong reflection of radiation over a certain frequency range and high transmission outside this range. The center frequency depth and, to a lesser extent, width of a stop band are established by design. Hence, the stop band can be tailored to specific circuitry and components requirements. Thus, in the case of FSS's, additional stopgaps can be designed by the periodicity of the resonant LC circuit of the cells and the clusters.

The bandwidth of a parallel LC circuit increases as a function of L/C, as shown in FIGS. 12A and 12B. In these figures, the reflection coefficient (gamma) phase angle and the impedance magnitude are plotted for a transmission line model of a parallel LC high-impedance surface. Of course, this is a simplified model for the high-impedance ground plane. The two cases shown in FIGS. 12A and 12B assume a resonant frequency of 1 Mrad/sec and an L/C ratio of 1 and 10, respectively. As can be seen from these figures, the larger the L/C ratio, the broader the response in the parallel LC tank.

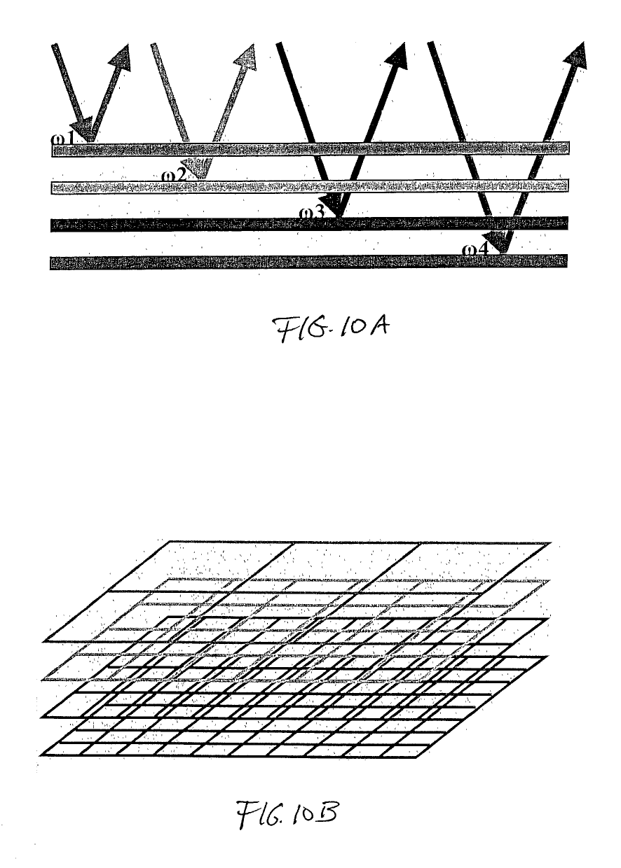

To take advantage of enhancing the broadband properties of LC resonant surfaces, labyrinth geometries may be used to achieve very large inductive values on a high impedance surface. According to one embodiment, the meandering geometries of a fractal design may be used to induce a large inductive impedance. One such highly inductive FSS is shown in FIG. 13. In addition to meandering geometries, stochastic or random pattern geometries may be used. More details of self-similar, pseudo fractal, and stochastic designs are given in the afore-mentioned copending U.S. patent application Ser. No. 10/072,739. In addition to these designs, other configurations are possible, as discussed below.

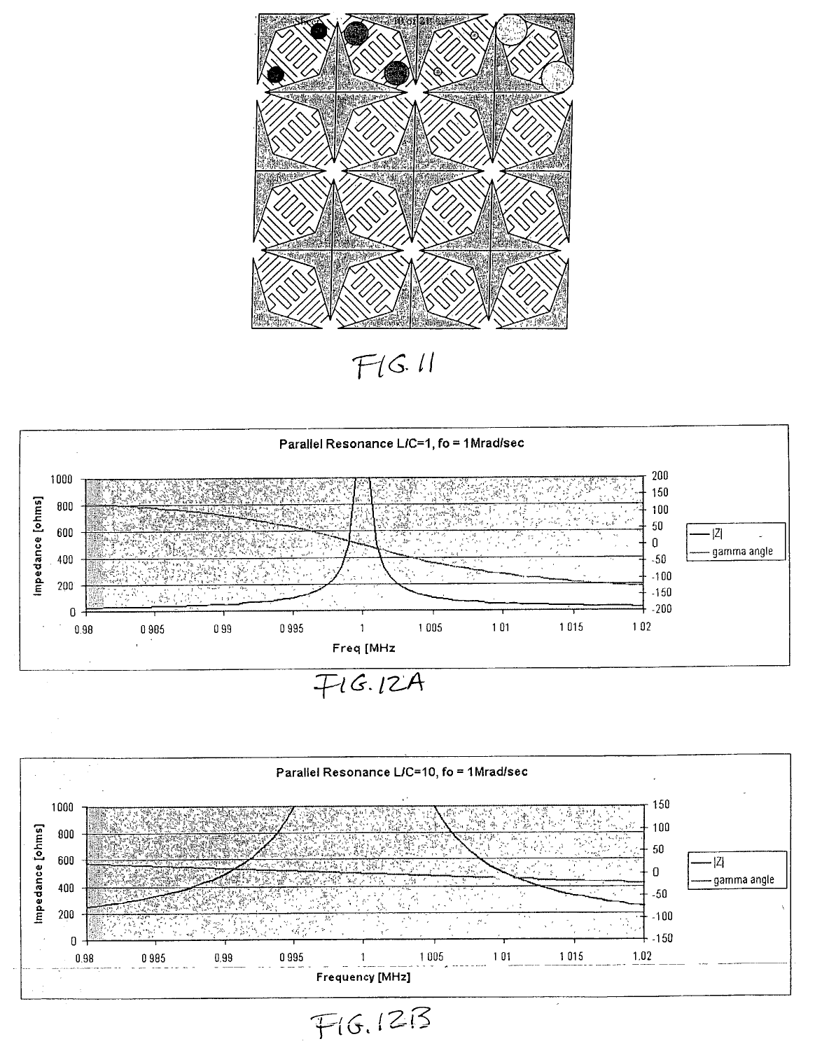

The behavior of conventional high-impedance FSSs has traditionally been described using a parallel LC model that reflects at all frequencies, with the reflection phase changes as a function of frequency. The frequency reflection phase goes through 0 degrees when the LC circuit resonates (the desired operating point). An exemplary structure with this design is shown in FIGS. 14A-C.

According to an exemplary embodiment, a high impedance surface may be constructed using fractal elements or “molecules” instead of the conventional “tack head” structure shown in FIGS. 14A-C to achieve a very large meandering inductances. A highly meandering fractal ground plane structure may be used to achieve additional inductance. As one example, the fractal ground plane may have a Hilbert self-similar curve due to its unique space filling properties, i.e., high inductive surface. These vary large inductances will maximize the FSS's bandwidth. Likewise, pseudo-self-similar geometrical structures and stochastic designs may be used.

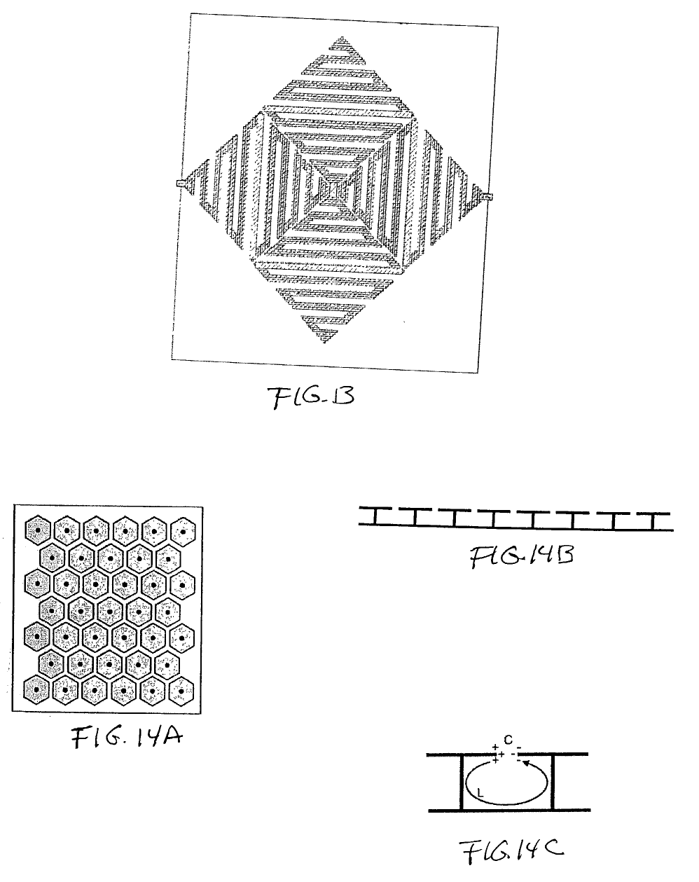

According to this embodiment, the FSS may include meandering geometries on a first layer connected to the meandering ground plane with vias. Capacitance is achieved by closely spacing the cells on the top layer. An example of this type of structure is shown in FIGS. 15A and 15B, in which the fractal conducting plane is represented as 1500, and the fractal molecules are represented as 1505. Multiple unique meandering and pseudo self similar geometries may also be used to achieve multiband resonance.

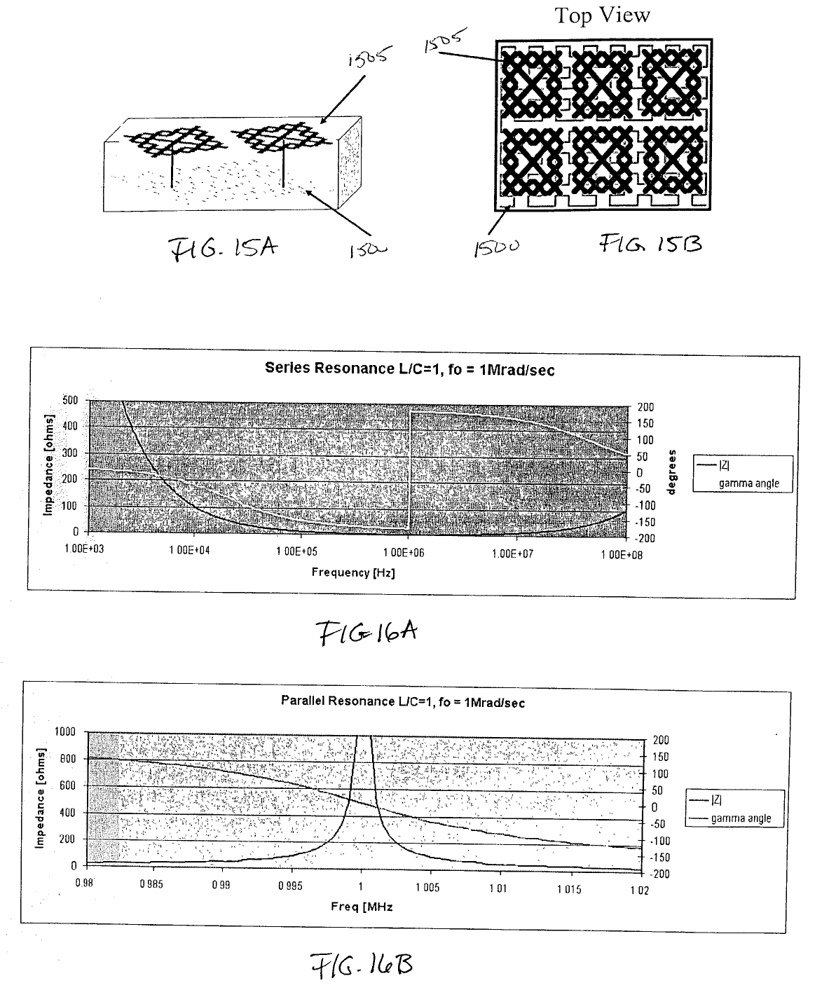

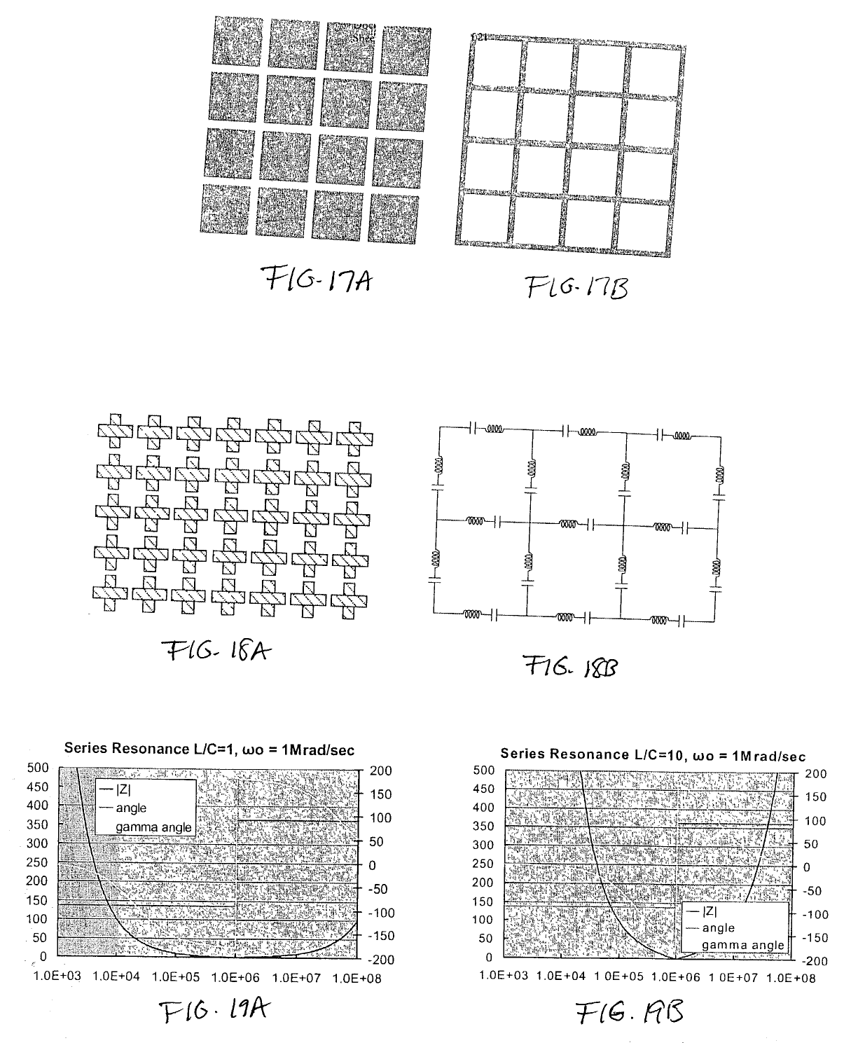

In the descriptions above, a parallel LC high-impedance FSS uses the narrow stop band located at the resonant frequency to suppress surface waves on a substrate. According to another embodiment, a series LC FSS structure may be used to exhibit high impedance surface properties on either side of resonance. By locating the resonant frequency of a series LC FSS at a much higher frequency than the operating frequency of an antenna, the frequency response of the series FSS below resonance may be used. For example, the resonant frequency of the series LC FSS may be located at 100 GHz for 2 GHz operation. The radiation from an antenna will not be able to excite surface waves on the FSS, because the surface impedance appears too high in this frequency range. So, the radiation reflects in phase and doubles the antenna output, as with a parallel LC FSS. The reflection coefficient responses of series and parallel LC circuits are shown in FIGS. 16A and 16B, respectively. These figures show plots of impedance magnitude and reflection coefficient phase angle vs. frequency of a series/parallel LC load attached to the end of a transmission line. This is an easily modeled representation of an FSS exposed to EM radiation. It should be appreciated that this analysis is based on a somewhat simplified model of the high-impedance ground plane. The results may change slightly when more complex models are used to describe the behavior. The use of series LC circuits within an FSS are not limited to reflective properties of high-impedance surfaces but are intended for use in all FSSs and PBGs.

Purely capacitive or purely inductive FSSs have been proposed, as shown in FIGS. 17A and 17B. The purely capacitive surface is typically formed as a sheet of thin metal islands, as shown in FIG. 17A. The inductive surface is typically formed as a grid of conductive lines, as shown in FIG. 17B.

The capacitive surface effectively suppresses surface waves at low frequencies because the current cannot travel across the gaps. At very high frequencies when the capacitors behave as shorts, surface waves can propagate. However, over the frequency range where it prohibits surface waves, it is only partially reflective and thus non an effective PMC.

On the inductive surface, surface waves are suppressed at high frequency because the surface impedance is high. For the inductive FSS, waves that are short compared to the diameter of the holes will easily fit through the mesh, while longer waves see the sheet as continuous metal and will reflect. The problem is that at low frequencies where the inductive surface reflects, surface waves can easily propagate down the solid metal lines. Thus, the inductive surface behaves as a PEC.

According to an exemplary embodiment, a series LC FSS has the desirable effects of both purely capacitive and purely inductive surfaces. The surface has a high inductance as in the inductive surface, with “holes” much smaller than a wavelength. However, surface waves at low frequencies are prevented from propagating by breaks in the inductive lines, creating small capacitors. One periodic geometry of a series FSS is an array of “pluses”, as shown in FIG. 18A. FIG. 18B illustrates a circuit equivalent of the structure shown in FIG. 18A.

The bandwidth of any resonant circuit is a function of the ratio of L/C. As discussed earlier, for parallel LC circuits, the bandwidth increases as L/C increases. Thus, according to an exemplary embodiment, the best geometry for the series periodic LC FSS is one that has a large L/C ratio, e.g., a largely inductive surface having a fractal geometry.

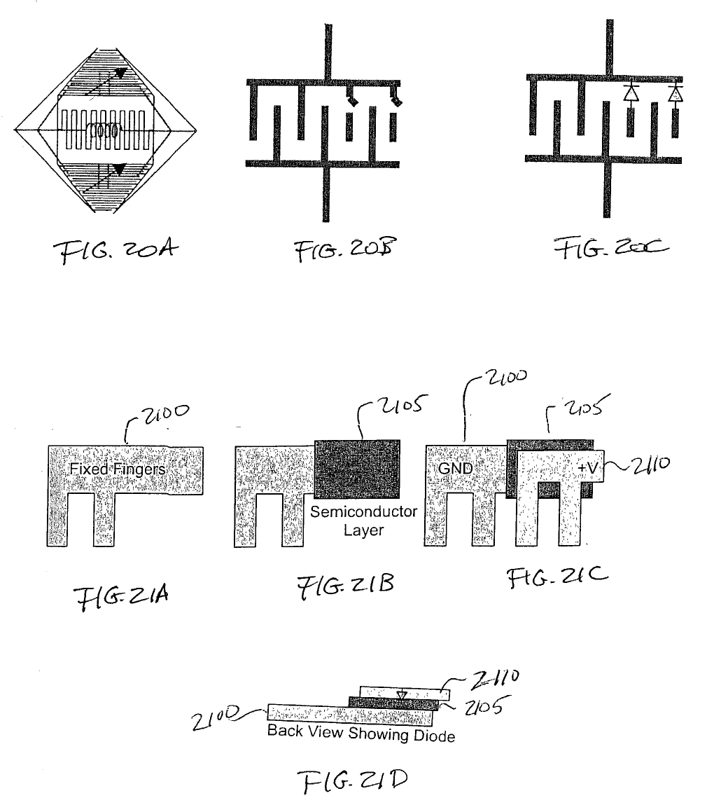

For series circuits, the bandwidth increases as L/C decreases. However, it is desired that the series LC circuit displays a narrowband width so that a wider high impedance band will be exhibited below series resonance. Thus, it is advantageous to make the L/C large. This may be understood with reference to the modeling results shown in FIGS. 19A and 19B which depict simulations of how L/C affects the bandwidth of the series LC circuit. According to an exemplary embodiment, a larger L/C may be achieved by making the plus signs in the design shown in FIG. 18A meandering. However, other geometries, such as pseudo-fractal and stochastic, may be used to provide a series LC circuit with a large inductance.

In addition to the parallel and series LC FSSs described above, according to another embodiment, a FSS is provided that is tunable. For tuning of the FSS, a field tunable dielectric, such as barium strontium titanate (BST), may be used as the substrate. BST thin film parallel plate capacitors have been tested to yield 60% tunability between 45 MHz and 200 MHz using a 17 V DC bias with a loss tangent of 0.004. Higher frequency (1-3 GHz) material tunability are required to work for the wireless and communications bands. The FSS may be placed on a BST substrate and thereby tuned with an applied DC voltage. Biased ferrite materials may also be used as a tunable substrate for the FSS.

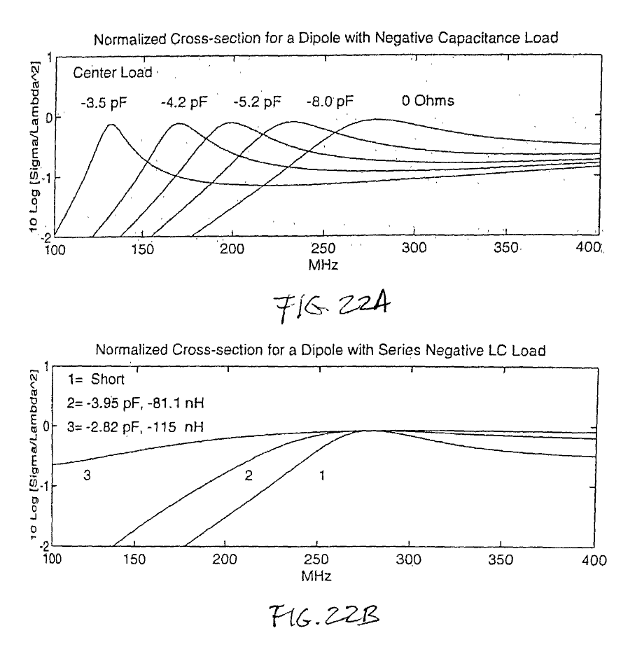

According to another embodiment, an FSS may be made tunable using tunable interdigitated capacitors and/or tunable meandering line inductors. An example of a tunable FSS with tunable interdigitated capacitors is shown in FIG. 20A. The capacitance is changed by selectively turning on and off fingers. As shown in FIGS. 20B and 20C, diodes or transistors may be used to electrically connect or disconnect the fingers by applying a DC forward bias to the device.

According to one embodiment, standard, off-the-shelf diodes and transistors may be used as switches.

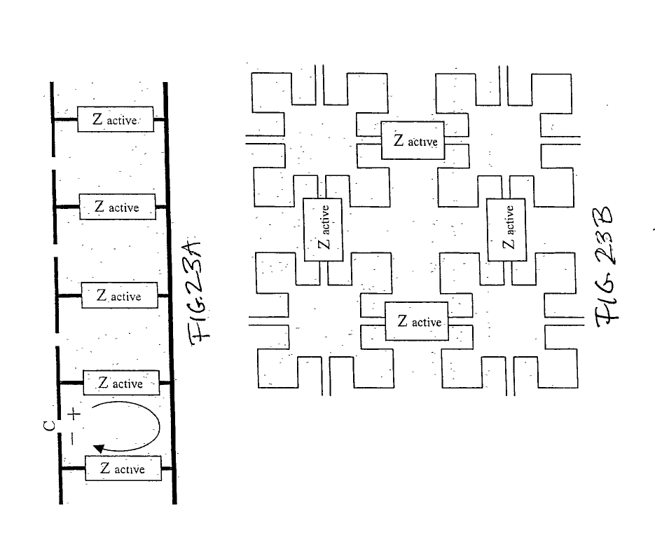

Alternatively, the diodes may be built into the capacitor during manufacture. For example, the diodes may be built into the FSS by placing a semiconductor between the switchable fingers and the FSS. An example of this embodiment is shown in FIGS. 21A-21D. As shown in FIG. 21A, permanent metal fingers 2100 are fabricated. Then, as shown in FIG. 21B, a layer of semiconductor material 2105 is put on top of the first metal layer. As shown in FIG. 21C, the switchable fingers 2110 are then layered on top of the semiconductor. An edge view of this embodiment is shown in FIG. 21D. The work functions of the metal must be chosen such that the metal of the switchable fingers and the semiconductor form the desirable diode, while the lower metal/semiconductor junction is not used.

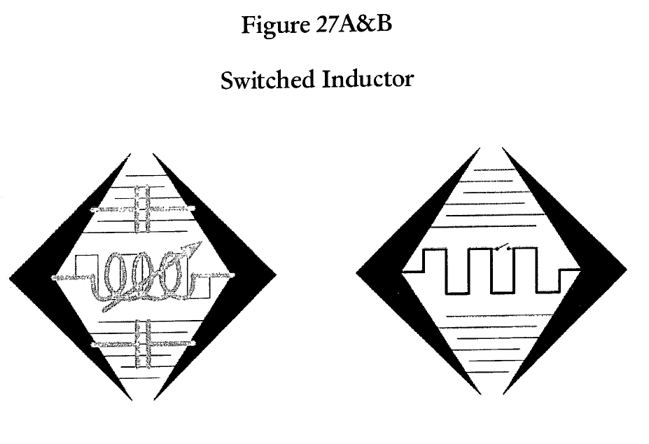

According to an exemplary embodiment, the semiconductor layer may be replaced by a photoconductive layer. The fingers may then be electrically connected by shining a light on the FSS. To make the photoconductive material more accessible to light, it may fill a gap in the metal finger instead of being layered. In a similar manner, the proposed switching schemes may be used to alter the inductance of an inductor by opening or closing an inductance modifying path within the inductor. This is illustrated in FIG. 27. A switch is used to open or close a shorting link within the inductor, effectively adding or removing one meandering path.

In addition to the concepts described above, according to an exemplary embodiment, entire molecules or areas on an FSS may be turned on and off. For example, entire inductors or capacitors may be electrically connected or disconnected from the surface.

According to an exemplary embodiment, certain cells or areas of the FSS may be tuned to various frequencies, a tuned-phase surface may be created. By creating a surface possessing different phase responses, an antenna beam may be actively steered, focused, or both.

According to an exemplary embodiment, active circuitry including negative impedance elements may be used in conjunction with FSS elements to achieve a significant amount of tunability or to achieve an ultra-wideband performance. One or more of the following components may be used: negative resistor, negative inductors, and negative capacitors. It will be appreciated that the terminology “negative” is used here to represent an artificially created negative impedance devise through the use of active devices and feedback techniques. For example, a tunnel diode may be configured to behave as a negative resistance and to function as an amplifier or oscillator.

The effects of negative loads may be understood with reference to FIGS. 22A and 22B. FIG. 22A shows exemplary plots of how the resonant frequency of the backscatter cross-section of a dipole may be changed by changing the value of a negative capacitive load. FIG. 22B shows how the resonance of the dipole element may be considerably broadened by introducing a series negative LC load. Besides providing the capability of being tuned, an active negative-impedance load can be used to obtain amplification of an incident EM wave, amplify an outgoing wave when used in conjunction with an antenna, or to generate RF energy directly.

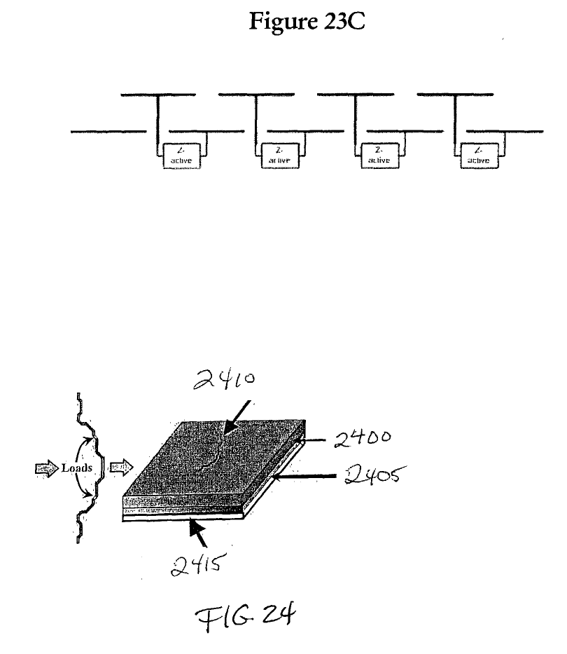

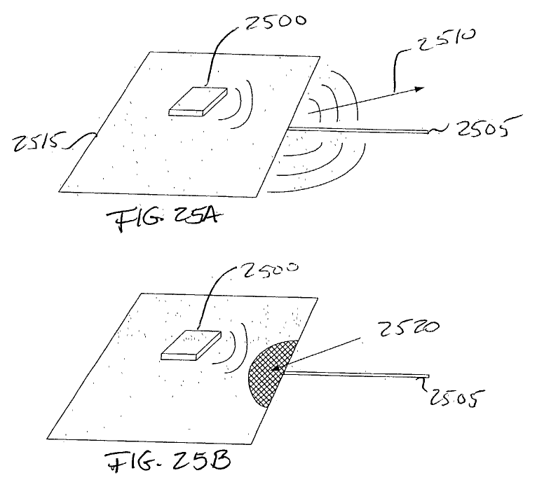

In addition to negative loads, other types of active components that may be used with FSS elements to achieve significant tunability include higher-order and fractional impedance elements. FIGS. 23A, 23B, and 23C illustrate active loads placed, for example, on the inductive branches of a planar type FSS and at the base of the posts of a Sievenpiper-type FSS, respectively, to achieve tunability and wide band performance. It will be appreciated that other embodiments for the placement of active loads are possible in the FSS.

According to the exemplary embodiments described above, a reduced size antenna system may be created that uses a tunable and/or multi-band and/or broadband FSS for increased gain, beam quality, or beam steering. The FSS may be used in conjunction with an antenna that has, e.g., a self-similar, pseudo self-similar, or random pattern.

An exemplary versatile antenna package incorporating an FSS as described in the embodiments above is shown in FIG. 24. The antenna 2140 is placed on a superstrate 2400 which is placed on a high impedance surface 2405. Alternatively, the high impedance surface may be placed upon a substrate, with the antenna placed beneath the substrate. Active devices for tunability, represented in FIG. 24 as element 2415, may be placed adjacent to the high impedance surface. Consequently, antennas can be made more compact and electrically larger to achieve superior performance in many applications. For example, these high impedance surfaces enable low-profile, flexible, and high gain antenna.

Another application of FSSs is in printed circuit board (PCB)/cable systems.

It is well established that an improperly designed printed circuit board (PCB) system may radiate radio frequency energy by allowing RF energy to couple onto any attached cables. Also, such a system may be susceptible to external interference by allowing energy coupled onto attached cables to enter the PCB.

According to exemplary embodiments, an FSS or PBG may be applied to the PCB during the etching process or may be designed into the cable's connector housing. Doing so helps decouple the cables from the PCB, thereby increasing the PCB's electromagnetic compatibility with surrounding equipment.

FIGS. 25A and 25B illustrate an exemplary embodiment of an FSS implemented in a PCB. In FIG. 25A, a typical PCB/cable arrangement is depicted. Poor or difficult layout causes unwanted current from the microprocessor 2500 to couple onto the attached cable 2505, producing unwanted radiation 2510. FIG. 25B shows an FSS 2520 that is applied to through planes of the PCB into the areas of the attached cables. By incorporating the FSS near the cable, unwanted RF currents are blocked from escaping onto the cable, and the system does not radiate.

In addition to implementations in antenna systems and PCB/cable systems, it will be appreciated that other uses for FSS and PBGs may also exist, e.g., in the area of electromagnetic compatibly applications (EMC) to prevent unwanted radiation or susceptibility.

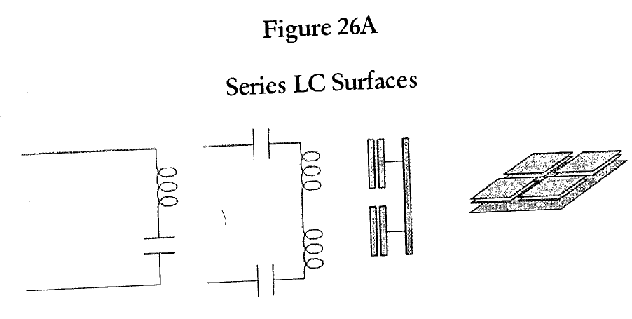

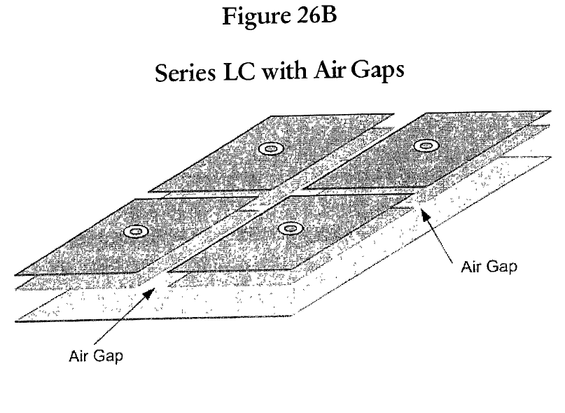

For example, a series LC high-impedance surface is shown in FIGS. 26A and 26B. FIG. 26A shows the progression from transmission-line model through realization. FIG. 26B shows the realization in more depth. The results of the transmission line model are shown in FIG. 16A.

According to exemplary embodiments, a more effective antenna and/or RF absorbing material or RF scattering material may be produced by transforming a substrate material into a FSS as described above. A passive and active, multiband and broad-band frequency selective surface may be produced and integrated with antennas. FSSs can filter, tune, transform, match, and operate on electromagnetic energy in ways giving an engineer new tools from which to choose.

It should be understood that the foregoing description and accompanying drawings are by example only. A variety of modifications are envisioned that do not depart from the scope and spirit of the invention.

The above description is intended by way of example only and is not intended to limit the present invention in any way.

What is claimed is:

1. A frequency selective surface, comprising:
a pattern of electromagnetic material formed on a substrate suspendable over a ground plane for reflecting or transmitting electromagnetic waves at one or more particular frequencies;
one or more meandering line inductors and/or one or more interdigitated capacitors formed within the pattern of electromagnetic materials for adjusting the frequencies at which the electromagnetic waves are reflected or transmitted.

2. The frequency selective surface of claim 1, wherein the electromagnetic waves propagate in free space or are surface currents or transmission line currents.

3. The frequency selective surface of claim 1, wherein the pattern of electromagnetic materials and the meandering line inductors and/or interdigitated capacitors affect a phase of at least one electromagnetic wave that is reflected or transmitted.

4. The frequency selective surface of claim 1, wherein the inductors and/or capacitors are arranged in one or more cells, and the cells are arranged within the frequency selective surface in a periodic design.

5. The frequency selective surface of claim 1, wherein the inductors and/or capacitors are arranged in one or more cells, and the cells are arranged within the frequency selective surface in a space-saving design.

6. The frequency elective surface of claim 1, wherein the inductors and/or capacitors are arranged within one or more cells in a space-saving design.

7. The frequency selective surface of claim 1, wherein the electromagnetic waves are caused to be reflected or transmitted at multiple frequencies by distributed or parasitic effects in the inductors and/or the capacitors.

8. The frequency selective surface of claim 1, wherein the inductors and/or the capacitors are arranged in one or more cells, and distributed or parasitic effects in the inductors and/or the capacitors cause each cell to reflect or transmit electromagnetic waves at multiple frequencies.

9. The frequency selective surface of claim 1, wherein multiple inductors and/or multiple capacitors are included in cells, such that each cell reflects or transmits electromagnetic waves at multiple frequencies.

10. The frequency selective surface of claim 1, wherein inductance values and capacitance values are adjusted by varying the geometries of the inductors and capacitors, respectively.

11. The frequency selective surface of claim 1, wherein the inductors and/or capacitors are arranged in cells, and the cells are arranged in clusters.

12. The frequency selective surface of claim 11, wherein within each cluster, at least one cell reflects or transmits electromagnetic waves at at least one frequency that is different from at least one other frequency at which at least one other cell within the same cluster reflects or transmits electromagnetic waves.

13. The frequency selective surface of claim 11, wherein the clusters are arranged in the electromagnetic pattern in rows and columns such that each row and each column has at least one cell that reflects or transmits electromagnetic waves at at least one frequency and at least one other cell that reflects or transmits electromagnetic waves at at least one different frequency.

14. The frequency selective surface of claim 11, wherein the clusters are arranged in the electromagnetic pattern such that cells that reflect or transmit electromagnetic waves at each different frequency are evenly distributed across a surface of the pattern.

15. The frequency selective surface of claim 1, wherein a frequency at which electromagnetic waves are reflected or transmitted is adjusted by applying magnetic and/or dielectric material on either side or both sides of the pattern of electromagnetic material.

16. The frequency selective surface of claim 15, wherein the inductors and/or capacitors are arranged in cells within the electromagnetic pattern, and the frequency at which electromagnetic waves are reflected or transmitted for each individual cell is adjusted by applying magnetic and/or dielectric material on either side or both sides of the pattern of electromagnetic material within the cell. different from at least one other frequency at which at least one other cell within the same cluster reflects or transmits electromagnetic waves.

13. The frequency selective surface of claim 11, wherein the clusters are arranged in the electromagnetic pattern in rows and columns such that each row and each column has at least one cell that reflects or transmits electromagnetic waves at at least one frequency and at least one other cell that reflects or transmits electromagnetic waves at at least one different frequency.

14. The frequency selective surface of claim 11, wherein the clusters are arranged in the electromagnetic pattern such that cells that reflect or transmit electromagnetic waves at each different frequency are evenly distributed across a surface of the pattern.

15. The frequency selective surface of claim 1, wherein a frequency at which electromagnetic waves are reflected or transmitted is adjusted by applying magnetic and/or dielectric material on either side or both sides of the pattern of electromagnetic material.

16. The frequency selective surface of claim 15, wherein the inductors and/or capacitors are arranged in cells within the electromagnetic pattern, and the frequency at which electromagnetic waves are reflected or transmitted for each individual cell is adjusted by applying magnetic and/or dielectric material on either side or both sides of the pattern of electromagnetic material within the cell.

17. The frequency selective surface of claim 15, wherein the magnetic and/or dielectric materials are intermixed to cause multiband or wide-band reflection or transmission of the electromagnetic waves.

18. The frequency selective surface of claim 11, wherein an array of cells that reflects or transmits electromagnetic waves at different frequencies is created by applying an array of same dielectric material of different dimensions to the capacitors and/or an array of same permeability material of different dimensions to the inductors.

19. The frequency selective surface of claim 1, wherein the frequency selective surface includes multiple layers, at least one layer of the multiple layers having a pattern of electromagnetic material with meandering line inductors and/or interdigitated capacitors formed on a substrate therein, and wherein the multiple layers are stacked together to cause the electromagnetic waves to be reflected, or transmitted at multiple frequencies.

20. The frequency selective surface of claim 1, wherein the meandering line inductors and/or the interdigitated capacitors are arranged in a self-similar pattern, a pseudo self-similar pattern, or a stochastic, substantially random pattern.

21. The frequency selective surface of claim 1, wherein the ground plane includes a self-similar pattern, a pseudo self-similar pattern, or a stochastic, substantially random pattern of electromagnetic materials.

22. The frequency selective surface of claim 1, wherein the frequency selective surface prevents unwanted escape of some electromagnetic waves from the substrate while allowing electromagnetic waves at particular frequencies to escape.

23. The frequency selective surface of claim 1, wherein the frequency selective surface is formed in an area of a printed circuit board at which cables are attached to block some unwanted electromagnetic waves from escaping onto the cables while allowing electromagnetic waves at particular frequencies to escape.

24. The frequency selective surface of claim 1, wherein the frequency selective surface is used in conjunction with an antenna.

25. A frequency selective surface, comprising:
a pattern of electromagnetic materials formed on a substrate suspendable over a ground plane to reflect or transmit electromagnetic waves at one or more frequencies; and
one or more inductors and/or one or more capacitors arranged in series within the pattern of electromagnetic materials to adjust the frequencies at which the electromagnetic waves are reflected or transmitted.

26. The frequency selective surface of claim 25, wherein the electromagnetic waves propagate in free space or are surface currents or transmission line currents.

27. The frequency selective surface of claim 25, wherein the pattern of electromagnetic materials and the meandering line inductors and/or interdigitated capacitors affect a phase of at least one electromagnetic wave that is reflected or transmitted.

28. The frequency selective surface of claim 25, wherein the inductors and/or capacitors are arranged in one or more cells, and the cells are arranged within the frequency selective surface in a periodic design.

29. The frequency selective surface of claim 25, wherein the inductors and/or capacitors are arranged in one or more cells, and the cells are arranged within the frequency selective surface in a space-saving design.

30. The frequency selective surface of claim 25, wherein the inductors and/or capacitors are arranged within one or more cells in a space-saving design.

31. The frequency selective surface of claim 25, wherein the electromagnetic waves are caused to be reflected or transmitted at multiple frequencies by distributed or parasitic effects in the inductors and/or the capacitors.

32. The frequency selective surface of claim 25, wherein the inductors and/or the capacitors are arranged in one or more cells, and distributed or parasitic effects in the inductors and/or the capacitors cause each cell to reflect or transmit electromagnetic waves at multiple frequencies.

33. The frequency selective surface of claim 25, wherein multiple inductors and/or multiple capacitors are included in cells, such that each cell reflects or transmits electromagnetic waves at multiple frequencies.

34. The frequency selective surface of claim 25, wherein inductance values and capacitance values are adjusted by varying the geometries of the inductors and capacitors, respectively.

35. The frequency selective surface of claim 25, wherein the inductors and/or capacitors are arranged in cells, and the cells are arranged in clusters.

36. The frequency selective surface of claim 35, wherein within each cluster, at least one cell reflects or transmits electromagnetic waves at at least one frequency that is different from at least one other frequency at which at least one other cell within the same cluster reflects or transmits electromagnetic waves.

37. The frequency selective surface of claim 35, wherein the clusters are arranged in the electromagnetic pattern in rows and columns such that each row and each column has at least one cell that reflects or transmits electromagnetic waves at at least one frequency and at least one other cell that reflects or transmits electromagnetic waves at at least one different frequency.

38. The frequency selective surface of claim 35, wherein the clusters are arranged in the electromagnetic pattern such that cells that reflect or transmit electromagnetic waves at each different frequency are evenly distributed across a surface of the pattern.

39. The frequency selective surface of claim 25, wherein a frequency at which electromagnetic waves are reflected or transmitted is adjusted by applying magnetic and/or dielectric material on either side or both sides of the pattern of electromagnetic material.

40. The frequency selective surface of claim 39, wherein the inductors and/or capacitors are arranged in cells within the electromagnetic pattern, and the frequency at which electromagnetic waves are reflected or transmitted for each individual cell is adjusted by applying magnetic and/or dielectric material on either side or both sides of the pattern of electromagnetic material within the cell.

41. The frequency selective surface of claim 39, wherein the magnetic and/or dielectric materials are intermixed to cause multiband or wide-band reflection or transmission of the electromagnetic waves.

42. The frequency selective surface of claim 35, wherein an array of cells that reflects or transmits electromagnetic waves at different frequencies is created by applying an array of same dielectric material of different dimensions to the capacitors and/or an array of same permeability material of different dimensions to the inductors.

43. The frequency selective surface of claim 25, wherein the frequency selective surface includes multiple layers, at least one layer of the multiple layers having a pattern of electromagnetic material with meandering line inductors and/or interdigitated capacitors formed on a substrate therein, and wherein the multiple layers are stacked together to cause the electromagnetic waves to be reflected, or transmitted at multiple frequencies.

44. The frequency selective surface of claim 25, wherein the meandering line inductors and/or the interdigitated capacitors are arranged in a self-similar pattern, a pseudo self-similar pattern, or a stochastic, substantially random pattern.

45. The frequency selective surface of claim 25, wherein the ground plane includes a self-similar pattern, a pseudo self-similar pattern, or a stochastic, substantially random pattern of electromagnetic materials.

46. The frequency selective surface of claim 25, wherein the inductors and/or the capacitors are arranged in a self-similar, a pseudo self-similar pattern, a meandering pattern, or a stochastic, substantially random pattern.

47. The frequency selective surface of claim 25, wherein the frequency selective surface prevents unwanted escape of some electromagnetic waves from the substrate while allowing electromagnetic waves at particular frequencies to escape.

48. The frequency selective surface of claim 25, wherein the frequency selective surface is formed in an area of a printed circuit board at which cables are attached to block some unwanted electromagnetic waves from escaping onto the cables while allowing electromagnetic waves at particular frequencies to escape.

49. The frequency selective surface of claim 25, wherein the frequency selective surface is used in conjunction with an antenna.

50. A frequency selective surface, comprising:
a pattern of electromagnetic materials formed within a substrate suspendable over a ground plane to reflect or transmit electromagnetic waves at one or more frequencies, wherein the pattern is arranged in such a manner that the frequencies at which the electromagnetic waves are reflected or transmitted are tunable.

51. The frequency selective surface of claim 50, wherein the electromagnetic waves propagate in free space or are surface currents or transmission line currents.

52. The frequency selective surface of claim 50, wherein the pattern of electromagnetic materials affects a phase of at least one electromagnetic wave that is reflected or transmitted.

53. The frequency selective surface of claim 50, wherein the electromagnetic pattern is arranged in one or more cells, and the cells are arranged within the frequency selective surface in a periodic design.

54. The frequency selective surface of claim 50, wherein the electromagnetic pattern is arranged in one or more cells, and the cells are arranged within the frequency selective surface in a space-saving design.

55. The frequency selective surface of claim 50, wherein the electromagnetic pattern is arranged in one or more cells, and each cell reflects or transmits electromagnetic waves at multiple frequencies.

56. The frequency selective surface of claim 50, wherein the electromagentic pattern is arranged in cells, and the cells are arranged in clusters.

57. The frequency selective surface of claim 56, wherein within each cluster, at least one cell reflects or transmits electromagnetic waves at at least one frequency that is different from at least one other frequency at which at least one other cell within the same cluster reflects or transmits electromagnetic waves.

58. The frequency selective surface of claim 56, wherein the clusters are arranged in the electromagnetic pattern in rows and columns such that each row and each column has at least one cell that reflects or transmits electromagnetic waves at at least one frequency and at least one other cell that reflects or transmits electromagnetic waves at at least one different frequency.

59. The frequency selective surface of claim 56, wherein the clusters are arranged in the electromagnetic pattern such that cells that reflect or transmit electromagnetic waves at each different frequency are evenly distributed across a surface of the pattern.

60. The frequency selective surface of claim 50, wherein a frequency at which electromagnetic waves are reflected or transmitted is adjusted by applying magnetic and/or dielectric material on either side or both sides of the pattern of electromagnetic material.

61. The frequency selective surface of claim 50, wherein the electromagnetic pattern is arranged in cells, and the frequency at which electromagnetic waves are reflected or transmitted for each individual cell is adjusted by applying magnetic and/or dielectric material on either side or both sides of the pattern of electromagnetic material within the cell.

62. The frequency selective surface of claim 60, wherein the magnetic and/or dielectric materials are intermixed to cause multiband or wide-band reflection or transmission of the electromagnetic waves.

63. The frequency selective surface of claim 50, wherein the frequency selective surface includes multiple layers, at least one layer of the multiple layers having a pattern of electromagnetic material formed on a substrate therein, and wherein the multiple layers are stacked together to cause the electromagnetic waves to be reflected, or transmitted at multiple frequencies.

64. The frequency selective surface of claim 50, wherein the ground plane includes a self-similar pattern, pseudo self-similar pattern, or stochastic, substantially random pattern of electromagnetic materials.

65. The frequency selective surface of claim 50, wherein the pattern of electromagnetic materials is formed on a substrate that is tunable.

66. The frequency selective surface of claim 65, wherein the substrate is tuned by applying an electric or magnetic field.

67. The frequency selective surface of claim 65, wherein the substrate is tuned by applying an AC or DC bias voltage or current.

68. The frequency selective surface of claim 65, wherein the substrate includes a field tunable dielectric and/or magnetic material.

69. The frequency selective surface of claim 68, wherein the dielectric is tuned by applying a bias current or voltage to change the dielectric constant of the dielectric and/or the magnetic material is tuned by applying a bias current or voltage to change the permeability of the magnetic material.

70. The frequency selective surface of claim 65, wherein the field tunable dielectric includes barium strontium titanate.

71. The frequency selective surface of claim 50, further comprising one or more tunable meandering-line inductors or interdigitated capacitors arranged within the pattern of electromagnetic material.

72. The frequency selective surface of claim 71, wherein the inductors and/or capacitors are arranged within one or more cells in a space-saving design.

73. The frequency selective surface of claim 71, wherein an array of cells that reflects or transmits electromagnetic waves at different frequencies is created by applying an array of same dielectric material of different dimensions to the capacitors and/or an array of same permeability material of different dimensions to the inductors.

74. The frequency selective surface of claim 71, wherein the meandering line inductors and/or the interdigitated capacitors are arranged in a self-similar pattern, pseudo self-similar pattern, or a stochastic, substantially random pattern.

75. The frequency selective surface of claim 71, wherein inductance values and capacitance values are adjusted by varying the geometries of the inductors and capacitors, respectively.

76. The frequency selective surface of claim 71, wherein inductance is changed by opening or shorting circuiting an inductance changing path of the line inductors, and capacitance is changed by connecting or disconnecting fingers of the interdigitated capacitors.

77. The frequency selective surface of claim 76, further comprising one or more diodes and/or transistors for opening or short circuiting the inductance changing path and/or for connecting or disconnecting the fingers of the interdigitated capacitors.

78. The frequency selective surface of claim 76, further comprising an optically activated device for opening or short circuiting the inductance changing path and/or for connecting or disconnecting the fingers of the interdigitated capacitors.

79. The frequency selective surface of claim 50, wherein the frequency selective surface is connected to an antenna to enable beam steering and/or focusing.

80. The frequency selective surface of claim 50, further comprising one or more active or passive loads.

81. The frequency selective surface of claim 80, wherein the active loads contain negative resistors, negative inductors, and/or negative capacitors.

82. The frequency selective surface of claim 80, wherein the active loads contain tunable elements such that the operating frequency of the FSS may be adjusted.

83. The frequency selective surface of claim 80, wherein the active load may be used to allow amplification of an incident radio frequency wave or amplification of an outgoing wave when used in conjunction with an antenna, used to generate RF energy, or used scatter incident radio frequency energy, with or without tunability.

84. The frequency selective surface of claim 50, wherein the frequency selective surface prevents unwanted escape of some electromagnetic waves from the substrate while allowing electromagnetic waves at particular frequencies to escape.

85. The frequency selective surface of claim 50, wherein the frequency selective surface is formed in an area of a printed circuit board at which cables are attached to block some unwanted electromagnetic waves from escaping onto the cables while allowing electromagnetic waves at particular frequencies to escape.

86. The frequency selective surface of claim 50, wherein the frequency selective surface is used in conjunction with an antenna.
